(19) United States
(12) Patent Application Publication
(10) Pub. No.: US 2004/0158815 A1
(43) Pub. Date: Aug. 12, 2004

(54) Complex adaptive systems

(76) Inventor: Anna Elizabeth Gezina Potgieter, Cape Town (ZA)

Correspondence Address: STITES & HARBISON PLLC, 1199 NORTH FAIRFAX STREET, SUITE 900, ALEXANDRIA, VA, 22314, US

(21) Appl. No.: 10/480,105

(22) PCT Filed: Jul. 5, 2002
(86) PCT No.: PCT/IB02/02645

(30) Foreign Application Priority Data
Jul. 9, 2001 (ZA) 2001/5608

(51) Int. Cl. G06F 9/44

(52) U.S. Cl. 717/120; 717/116

(57) ABSTRACT

The present invention relates to a complex adaptive system which comprises an intelligent software system for controlling behaviour in an application domain, the intelligent software system being deployed in an environment and being adapted to receive evidence from various sources in the environment, to learn from the evidence, and to modify the behaviour in order to adapt to changes in the environment. Also disclosed is a method for operating the complex adaptive system and computer-readable media storage instructions for carrying out the steps of the method of operating the complex adaptive system.

### FIELD OF INVENTION

The present invention relates to complex adaptive systems.

### BACKGROUND TO INVENTION

A complex adaptive system is a complex system that can learn from and adapt to a dynamically changing environment. A complex adaptive system is characterized by complex behaviours that emerge as a result of interactions among system components and the environment. Such a system interacts with its environment by learning from and modifying its behaviour in order to adapt to changes in its environment. Gel-Mann (1994) describes the following common feature of all complex adaptive systems:

a complex adaptive system acquires information about its environment and its own interaction with that environment, identifying regularities in that information, condensing those regularities into a kind of “schema” or model, and acting in the real world on the basis of that schema.

Open distributed environments, such as the Internet, place a growing demand on complex systems to be adaptive as well. The uncertainty in these environments is mostly due to the behaviour of other complex adaptive systems such as users browsing web pages, the behaviour of buyers and sellers on the Internet and the behaviour of autonomous agents bidding on behalf of persons in Internet auctions.

It is an object of the invention to suggest a novel complex adaptive system.

### SUMMARY OF INVENTION

According to the invention, a complex adaptive system comprises an intelligent software system for controlling behaviour in an application domain, the intelligent software system being deployed in an environment and being adapted to

(a) receive evidence from various sources in the environment;

(b) learn from the evidence; and

(c) modify the behaviour in order to adapt to changes in the environment.

Also according to the invention, a method of operating a complex adaptive system includes the steps of

(a) deploying in an environment an intelligent software system for controlling behaviour in an application domain; and

(b) adapting the intelligent software system for receiving evidence from various sources in the environment, for learning from the evidence; and for modifying the behaviour in order to adapt to changes in the environment.

Yet further the invention relates to computer-readable media storage instructions for carrying out the steps of the method of operating a complex adaptive system as described herein.

The intelligent software system may be a Bayesian network.

The environment may be a distributed environment.

The environment may be an open environment.

The environment may be the Internet.

The Bayesian network may comprise

(a) nodes representing variables of interest;

(b) node components for implementing and administering the nodes;

(c) links connecting a first node and a second node and representing dependencies among the variables of interest;

(d) link components for administering the links; and

(e) belief propagation components for propagating beliefs of the Bayesian network.

The Bayesian network may reside within a component framework having communication queues for implementing the links, and providing an infrastructure for the node components, the link components and the belief propagation components.

The links may be directional links from the first node to the second node whereby the first node is a parent node and the second node is a child node.

A belief propagation component may be provided for each communication queue.

The node components, the link components and the belief propagation components may be re-usable components.

The node components, the link components and the belief propagation components may be components of a component architecture.

The component architecture may be selected from the group comprising Sun's Enterprise JavaBeans™ and Microsoft's DCOM (Distributed Component Object Model).

The node components may be identical node components but created for different nodes.

The link components may be identical link components but created for different links.

The belief propagation components may be identical belief propagation components but created for different communication queues.

The learning may be incremental.

The system may comprise a database administered by the node components and the link components.

The database may comprise a topology of the Bayesian network.

The belief propagation components may communicate with each other directly via the communication queues by means of tags and indirectly via data in the database.

The various sources may be selected from the group comprising user-input data, data-sources and sensor data.

The tags may be simple messages controlling belief propagation.

The variables of interest may comprise a set of states.

The set of states may be a finite set of mutually exclusive states.

The states may be determined by the evidence.

The dependencies may represent informational dependencies among the variables of interest.

The dependencies may represent causal dependencies among the variables of interest.

The dependencies may be given in terms of conditional probabilities of states that a child node can have given the states of a parent node.

The conditional probabilities may be tabled in conditional probability matrices.

The system may comprise one conditional probability matrix per node.

The link from the parent node to the child node may be an incoming link of the child node and an outgoing link of the parent node.

The node components may receive evidence, maintain record of occurrences, maintain conditional probability matrices, and learn from evidence received from the various sources.

The belief propagation components may collectively find a most probable explanation (MPE) for the Bayesian network given the evidence.

The conditional probability matrices may be stored in the database.

The database may be distributed.

The propagating of beliefs may be localized for the parent node, a child node and the corresponding link between the parent node and the child node.

The node components may interface with the environment.

Each belief propagation component may administer the belief of the parent node and the parent's child node.

The belief propagation components may only communicate with belief propagation components of the parent node's links and the child node's links.

The learning may occur by updating the conditional probability matrices of the nodes in response to evidence.

The conditional probability matrix of a node may be updated by the node component of the specific node.

The belief propagation components may calculate π's and λ's for a parent node, a child node and a connecting link as in Judea Pearl's message passing algorithm.

The system may comprise no centralized control of the belief propagation.

The system may comprise control of the belief propagation and which control is distributed between the belief propagation components.

Each node component corresponding to any node X may maintain and administer:

(a) a conditional probability matrix (CPM) for node X;

(b) a prior probabilities vector π(x) as defined in Judea Pearl's Message Passing Algorithm;

(c) a likelihood vector λ(x) as defined in Judea Pearl's Message Passing Algorithm;

(d) history of occurrences for each state of node X;

(e) latest evidence received for the states of node X;

(f) a list of incoming links to node X;

(g) a list of outgoing links from node X;

(h) the name of node X, and

(i) a list of the states of node X.

Each link component corresponding to any link XY may maintain and administer

(a) π_{Y}(x) as defined in Judea Pearl's Message Passing Algorithm;

(b) λ_{Y}(x) as defined in Judea Pearl's Message Passing Algorithm; and

(c) synchronization flags.

Each node component corresponding to any node X may maintain and administer

(a) π(x) as defined in Judea Pearl's Message Passing Algorithm; and

(b) λ(x) as defined in Judea Pearl's Message Passing Algorithm.

The synchronization flags may be used by the belief propagation components to synchronize calculation of products of π's or λ's of links having a common parent node or a common child node.

The synchronization flags may comprise

(a) a PI-flag for keeping track if the link component corresponding to link XY has calculated π_{Y}(x) or not; and

(b) a LAMBDA-flag for keeping track if the link component corresponding to link XY has calculated λ_{Y}(x) or not.

Messages communicated on the communication queues may be simple tags.

The tags may comprise PI-tags and LAMBDA-tags for determining the direction of propagation of tags in the Bayesian Network.

If the Bayesian network is in learning mode, the evidence received from the environment may be added to history data, and the conditional probability table is updated, and if the Bayesian network is in query mode, no learning may take place, but the evidence is taken into account during belief propagation.

As soon as a belief propagation component receives a tag, the belief propagation components may identify the queue it received the tag on, in order to determine which link the queue corresponds to, and once the link is known to the belief propagation component, it may create the necessary link components and node components.

The PI-tag may trigger calculation of the link's π, and if all the child node's incoming links have calculated their link π's, then the child node's π may be calculated.

As soon as the child node's π is updated, PI-tags may be sent to the queues corresponding to its outgoing links, where-after the belief propagation component may go into a wait state, listening for the next tag to arrive on its queue.

The LAMBDA-tag may trigger the calculation of the link's λ, and if all the parent node's outgoing links have calculated their link λ's, then the parent node's λ may be calculated.

As soon as the parent node's λ is updated, LAMBDA-tags may be sent to the queues corresponding to the parent node's incoming links. If it is a node without any incoming links, PI-tags may be sent to the queues corresponding to the parent node's outgoing links, where-after the belief propagation component will go into a wait state, listening for the next tag to arrive on its queue.

Each belief propagation cycle may be a two-phase process, which is activated as soon as a set of evidence is received from the environment.

The two-phase process may comprise

(a) propagation of LAMBDA-tags from nodes without any outgoing links in the direction of predecessor nodes through the network gathering evidence from the environment; and

(b) thereafter flow of PI-tags from nodes without any incoming links in direction of children nodes, gathering a priori information.

The LAMBDA-tag may cause propagation of LAMBDA-tags in the direction of predecessor nodes, except if the parent of the link is a node without any incoming links, then the direction will be reversed and PI-tags will be propagated in the direction of the child nodes.

The PI-tag may cause propagation of PI-tags in the direction of child nodes, except if the child node of the link is a node without any outgoing links.

Each PI-tag received on a queue representing link XYⱼ, may trigger the following processing steps:

(a) creation of a link component corresponding to the link XYⱼ, as well as node components corresponding to nodes X and Yⱼ;

(b) using the node component interfaces to:

a. determine the names of the parent node (X) and the child node (Yⱼ) of this link;

b. retrieve a list of the names of all links that have the same parent as this link, namely all the other outgoing links of the common parent node;

c. retrieve a list of the names of all links that have the same child as this link, namely all the other incoming links of the common child node;

(c) for each of the other outgoing links of the parent node X, creation of a link component;

(d) retrieval of λ_{Y}_{ₖ}(x), k=1 . . . m, k j;

(e) calculation of the product of these link I's, namely

$${\prod }_{k \neq j} {λ}_{{Y}_{k}} ( x ) ;$$

(f) retrieval of the belief of node X, namely BEL(x);

(g) calculation of

$${π}_{{Y}_{j}} ( x ) = BEL ( x ) {\prod }_{k \neq j} {λ}_{{Y}_{k}} ( x ) ,$$

by using the product of λ's calculated in step (d); (h) setting of π_{Y}_{ⱼ}(x) and the corresponding PI-flag to indicate that this link has now calculated its π;

(i) testing if the other incoming links of child node Yⱼ have calculated their π's yet;

(j) if this link is the last link to calculate its π, the π for child node Yⱼ is calculated by:

a. setting a flag that will indicate to the link component to clear all the PI-flags for all the incoming links to node Yⱼ in order to be ready for synchronization in the next belief propagation cycle;

b. for each of the other incoming links of the child node Yⱼ, creation of a link component;

c. retrieval of π_{Y}_{ⱼ}(vᵢ), i=1 . . . p, where V₁,V₂ . . . Vₚ are the parents of the incoming links of node Yⱼ;

d. calculation of the product of these link π's, namely

$${\prod }_{k = 1}^{p} {π}_{{Y}_{j}} ( {v}_{k} ) ;$$

e. creation of a node component for child node Yⱼ;

f. calculation of the product of the conditional probability matrix and the product of the incoming link π's, calculated in step d giving

$$π ( {y}_{j} ) = {\sum }_{{v}_{1} … {v}_{p}} P ( {y}_{j} \vert {v}_{1} , … , {v}_{p} ) {\prod }_{k = 1}^{p} {π}_{{Y}_{j}} ( {v}_{k} ) ,$$

which is updated;

g. obtaining a list of names of all the outgoing links of this child node; and placement of a PI-tag on the communication queue corresponding to each of these link names.

Each LAMBDA-tag received on a queue, representing link XYⱼ, may trigger the following processing steps:

(a) creation of a link component corresponding to the link XYⱼ, as well as node components corresponding to nodes X and Yⱼ;

(b) using the node component interfaces to:

a. determine the names of the parent node (X) and the child node (Yⱼ) of this link;

b. retrieve a list of the names of all links that have the same parent as this link, namely all the other outgoing links of the common parent node;

c. retrieve a list of the names of all links that have the same child as this link, namely all the other incoming links of the common child node;

(c) for each of the other incoming links of the child node Yⱼ, creation of a link component and retrieval of π_{Y}_{ⱼ}(vᵢ), i=1 . . . p (where V₁ . . . Vₚ are the parents of the other incoming links of Yⱼ) and calculation of the product of the link π's, namely

$${\prod }_{k = 1}^{p} {π}_{{Y}_{j}} ( {v}_{k} ) ;$$

(d) creation of a node component for child node Yⱼ and determination child node's λ(yⱼ);

(e) multiplication of λ(yⱼ) with the conditional probability matrix and the product of the incoming link π's calculated in step (c) giving λ_{Y}

$${λ}_{{Y}_{j}} ( x ) = {\sum }_{{y}_{j}} [ λ ( {y}_{j} ) {\sum }_{{v}_{1} , … {v}_{p}} P ( {y}_{j} \vert x , {v}_{1} , {v}_{2 } … {v}_{p} ) {\prod }_{k = 1}^{p} {π}_{{Y}_{j}} ( {v}_{k} ) ] ;$$

(f) setting λ_{Y}_{ⱼ}(x) and the corresponding LAMBDA-flag to indicate that this link has now calculated its λ;

(g) testing if the other outgoing links of parent node X have calculated their λ's yet;

(h) if this link is the last link to calculate its λ, the λ for the parent node X can now be calculated by:

a. setting the LAMBDA-flag that will indicate to the link component to clear all the LAMBDA-flags for all the outgoing links from node X, in order to be ready for synchronization in the next belief propagation cycle;

b. for each of the other outgoing links of the parent node X, creation of a link component and retrieval of λ_{Y}_{ⱼ}(x), j=1 . . . m;

c. calculation of the product of these link λ's giving

$$λ ( x ) = {\prod }_{j = 1}^{m} {λ}_{{Y}_{j}} ( x )$$

which is updated;

d. obtaining a list of the names of all the incoming links of this parent node, and placement of a LAMBDA-tag on the communication queue corresponding to each of these link names; and

e. if node X has no incoming links, then get a list of names of al the outgoing links of this parent node, and placement of a PI-tag on the communication queue corresponding to each of these link names.

The node component corresponding to any node X may comprise the following component interfaces:

(a) an interface for initialising or resetting node X;

(b) node Bayesian network structure interfaces for enabling access to the topology of the Bayesian network;

(c) conditional probability matrix interfaces for enabling access to node X's conditional probability matrix and for performing calculations on the conditional probability matrix as defined in Judea Pearl's Message Passing Algorithm;

(d) node belief calculation interfaces for allowing access to π(x), λ(x) and BEL(x); and

(e) environmental interfaces for enabling interaction with the environment.

The node Bayesian Network structure interfaces for a node component corresponding to any node X may comprise component interfaces for:

(a) enabling access to the name of node X;

(b) retrieving of the number of states of node X;

(c) retrieving a list of descriptions of the states of node X;

(d) retrieving a list of the incoming links of node X; and

(e) retrieving a list of the outgoing links of node X.

The conditional probability matrix interfaces for a node component corresponding to any node X may comprise component interfaces for:

(a) setting the conditional probability matrix of node X;

(b) retrieving the conditional probability matrix of node X;

(c) multiplying the transpose of the conditional probability matrix of node X with an input array;

(d) multiplying the conditional probability matrix of node X with an input array.

The environmental interfaces for a node component corresponding to any node X may comprise interface components for:

(a) setting the observed evidence for node X;

(b) setting node X to “unobserved”, namely that no evidence was observed for this node; and

(c) retrieving evidence for node X.

The node belief calculations interfaces for a node component corresponding to any node X may comprise interface components for:

(a) retrieval of π(x);

(b) setting π(x);

(c) retrieval of λ(x);

(d) setting λ(x);

(e) retrieval of node's belief, namely BEL(x).

The link component corresponding to link XY may comprise the following component interfaces:

(a) an interface for initialising or resetting link XY;

(b) link Bayesian Network structure interfaces for enabling access to topology of the Bayesian network;

(c) link belief calculation interfaces for allowing access to π_{Y}_{ⱼ}(x) and λ_{Y}_{ⱼ}(x); and

(d) synchronization interfaces used by the belief propagation components for synchronizing calculation of products of π's or λ's of sibling links.

The Link Bayesian network interfaces for a link component corresponding to any link XY may comprise component interfaces for:

(a) retrieving the name of the parent node (X);

(b) retrieving the name of the child node (Y),

(c) retrieving of a list of the other outgoing links of the parent node (X); and

(d) retrieving a list of the other incoming links of the child node (Y).

The link belief calculation interfaces for a link component corresponding to any link XY may comprise component interfaces for:

(a) retrieval of π_{Y}(x);

(b) setting π_{Y}(x);

(c) retrieval of λ_{Y}(x); and

(d) setting λ_{Y}(x).

The synchronization interfaces for a link component corresponding to any link XY may comprise component interfaces for:

(a) setting flag to indicate that π_{Y}(x) for this link has been calculated;

(b) retrieval of flag that indicated if π_{Y}(x) for this link has been calculated or not;

(c) setting flag to indicate that λ_{Y}(x) for this link has been calculated; and

(d) retrieval of flag that indicates if λ_{Y}(x) for this link has been calculated or not;

(e) retrieval of a flag that indicates if all the incoming links of a node have calculated their link π's yet;

(f) setting a flag that will cause the link component to clear all the PI-Flags of all the child node's incoming links—ready for the calculation of the next product of π's;

(g) retrieval of a flag that indicates if all the outgoing links of a node, have calculated their link λ's yet; and

(h) setting a flag that will cause the link component to clear all the LAMBDA-flags of all the parent node's outgoing links—ready for the calculation of the next product of λ's.

### BRIEF DESCRIPTION OF DRAWINGS

The invention will now be described by way of example with reference to the accompanying schematic drawings.

In the drawings there is shown in:

FIG. 1 Implementation of a complex adaptive system in accordance with the invention;

FIG. 2 Propagation of π's and λ's in a network, as described by Diez (1996);

FIG. 3 Component diagram of a node component of a complex adaptive system as shown in FIG. 1;

FIG. 4 Component diagram of a link component of a complex adaptive system as shown in FIG. 1;

FIG. 5 A state diagram of a belief propagation component shown in FIG. 1;

FIG. 6 A Bayesian Network of a fictitious model of the browsing behaviour of users visiting an electronic bookstore website;

FIG. 7 The results of belief propagation in the presence of evidence of the Bayesian network shown in FIG. 6;

FIG. 8 A reference model for component-based concepts according to Bachman et al;

FIG. 9 A further diagram of the Bayesian network shown in FIG. 6;

FIG. 10 Yet a further diagram of the Bayesian network shown in FIG. 6;

FIG. 11 JMS queues for the links shown in FIG. 9;

FIG. 12 Components for the Bayesian network of FIG. 6;

FIG. 13 Output of the J2EE server on start-up of the Bayesian network shown in FIG. 6;

FIG. 14 Beliefs in the absence of evidence of the Bayesian network shown in FIG. 6;

FIG. 15 Output of a client setting evidence in order to query the Bayesian network shown in FIG. 6;

FIG. 16 First part of output trace of the belief propagation components in response to evidence presented to it in FIG. 15;

FIG. 17 Second part of the output trace of FIG. 16;

FIG. 18 Third part of the output trace of FIG. 16;

FIG. 19 Beliefs of the nodes after belief propagation with evidence and no learning of the Bayesian network shown in FIG. 6;

FIG. 20 Output of a client presenting evidence (that must be learnt) to the Bayesian network shown in FIG. 6;

FIG. 21 Results after belief propagation in the presence of evidence as presented in FIG. 20;

FIG. 22 New beliefs of the Bayesian network shown in FIG. 6, after learning and in the presence of no evidence from the environment; and

FIG. 23 Screen dump of the output of personalise Web-page of the Bayesian network shown in FIG. 6.

### DETAILED DESCRIPTION OF DRAWINGS

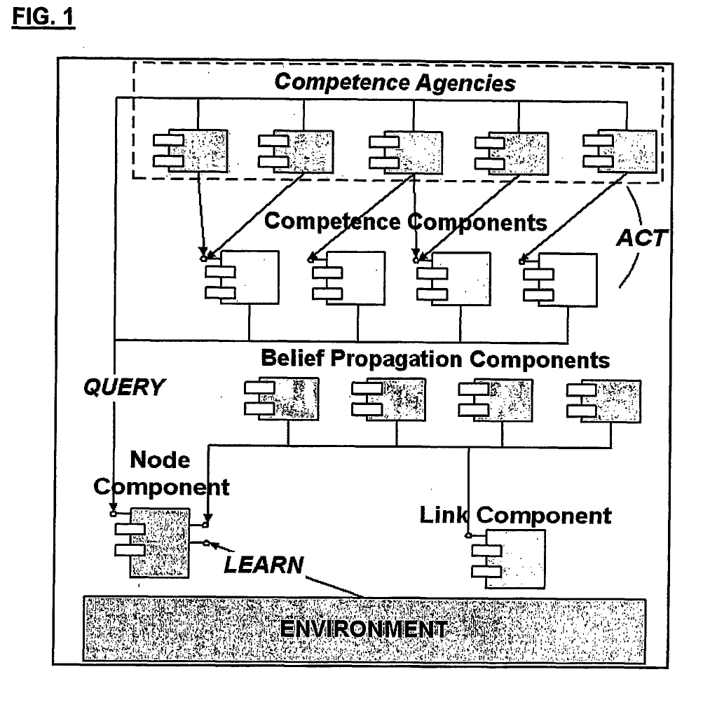

Referring to FIG. 1, the implementation of a complex adaptive system in accordance with the invention is shown. The complex adaptive system comprises an intelligent software system for controlling behaviour in an application domain, the intelligent software system being deployed in an environment and being adapted to

(a) receive evidence from various sources in the environment;

(b) learn from the evidence; and

(c) modify the behaviour in order to adapt to changes in the environment.

The intelligent software system is a Bayesian network which comprises

(a) nodes representing variables of interest;

(b) node components for implementing and administering the nodes;

(c) links connecting a first node and a second node and representing dependencies among the variables of interest;

(d) link components for administering the links; and

(e) belief propagation components for propagating beliefs of the Bayesian network.

The Bayesian network resides within a component framework having communication queues for implementing the links, and providing an infrastructure for the node components, the link components and the belief propagation components.

The algorithm of a complex adaptive system according to the invention is described hereafter. (In the specification hereinafter the expression “leaf node” is intended to refer to “node without any outgoing links”, and the expression “root node” is intended to refer to “node without any incoming links”.)

The node and link components administer and ensure persistence for the π's and λ's, beliefs and conditional probability matrices for the underlying Bayesian Network nodes. The node components provide interfaces to beliefs about the current environmental states, as environmental evidence is presented to the node components as soon as it occurs. As soon as evidence is received from the environment, the history data is updated, and the conditional probability matrices are incrementally updated (learning).

The belief propagation components are identical components, listening on different communication queues, corresponding to the links of the Bayesian Network links. These components propagate beliefs amongst themselves as in Judea Pearl's message passing algorithm. They communicate with each other through simple tags, as well as through data in a database administered by the node and link components. Using only the belief propagation, link and node components, a distributed Bayesian Network is assembled that learns from the environment and is queried by competence agencies to determine which component behaviours must be activated next, given the environmental states.

The competence agencies are application clients, each querying the beliefs of a set of node components and activating one or more component behaviours, depending on the beliefs of the queried node components. Each behaviour component executes a particular behaviour, and queries the states of one or more node components in order to use the beliefs in the particular behaviours.

There are three re-usable Bayes components that can be assembled into distributed Bayesian Networks. These components, together with a set of behavioural components specific to the problem domain, can be used to assemble complex adaptive systems, incrementally learning from the environment and activating component behaviours depending on environmental states.

The calculations in the Bayes components are based on Judea Pearl's message passing algorithm.

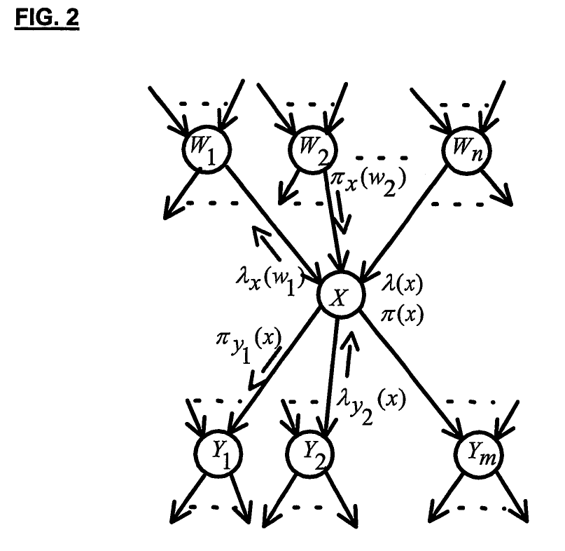

In a singly connected Bayesian network, that is a network without loops, an arbitrary node X divides the evidence into that connected to its causes e⁺_{X} (prior evidence) and that connected to its effects e⁻_{X} (observed evidence). A link XY divides the evidence into the evidence above the link, e⁺_{XY} and the evidence below the link, e⁻_{XY}. The messages propagated in a network, as described by Diez (1996), are defined in equations 1-5, and illustrated in FIG. 2.

The summarized effect on the belief of X by prior evidence e+, the prior probabilities vector is given by:

$$π ( x ) ≡ P ( x \vert {e}_{X}^{+} ) = {\sum }_{{w}_{1} , {w}_{2} , … {w}_{n}} P ( x \vert {w}_{1} , {w}_{2} , … , {w}_{n} ) {\prod }_{i = 1}^{n} {π}_{X} ( {w}_{i} ) \qquad ( 1 )$$

Summarized effect by diagnostic (or observed) evidence, e⁻, on our belief of X, the likelihood vector.

$$λ ( x ) ≡ P ( {e}_{x}^{-} \vert x ) = {\prod }_{j = 1}^{m} {λ}_{{Y}_{j}} ( x ) \qquad ( 2 )$$

Summarized effect of evidence above link XYⱼ is given by:

$${π}_{{Y}_{j}} ( x ) ≡ P ( x , {e}_{{XY}_{j}}^{+} π ( x ) = {\prod }_{k \neq j} {λ}_{{Y}_{k}} ( x ) \qquad ( 3 )$$

Summarized effect of evidence below link XYⱼ is given by:

$${λ}_{{Y}_{j}} ( x ) ≡ P ( {ⅇ}^{-} {XY}_{j} \vert x ) = {\sum }_{{y}_{j}}^{} [ λ ( {y}_{j} ) {\sum }_{{v}_{1} , {…v}_{p}}^{} P ( {y}_{j} \vert x , {v}_{1} , {v}_{2} … {v}_{p} ) {\prod }_{k = 1}^{p} {π}_{{Y}_{j}} ( {v}_{k} ) ] \qquad ( 4 )$$

where V₁, . . . , Vₚ are causes of Yⱼ other than X.

The belief of node X is:

BEL(x)≡P(x|e)=aπ(x)λ(x) (5)

where a=[P(e)]⁻¹ is a normalization constant to be computed after finding π(x) and λ(x).

Node Component

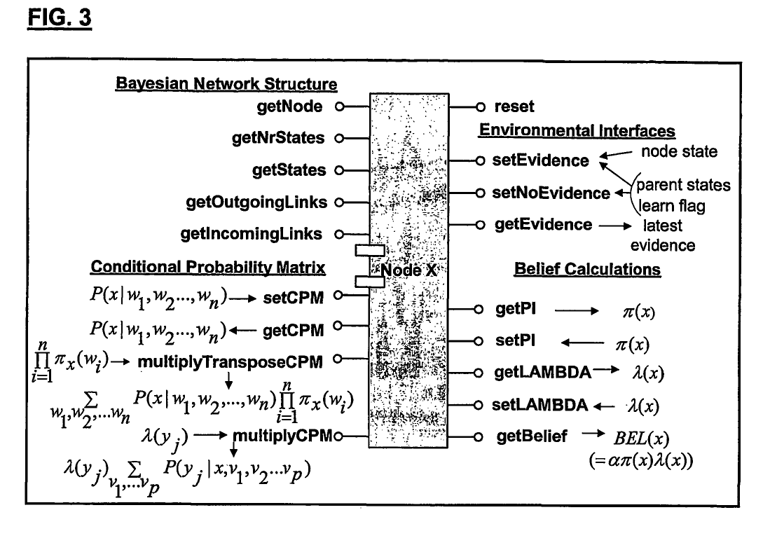

The component diagram for any node X is given in FIG. 3.

The node component maintains and administers:

the conditional probability matrix (CPM) for node X;

the prior probabilities vector π(x) (see equation 1);

the likelihood vector λ(x) (see equation 2);

history of occurrences for each state;

the latest evidence received for the states of the node;

a list of the incoming links to the node;

a list of the outgoing links to the node;

the name of the node, as well as a list of the states of the node.

In FIG. 3, the interfaces are grouped into four groups, namely the Bayesian Network structure interfaces, the conditional probability matrix interfaces, the belief calculation interfaces and the environmental interfaces.

The Bayesian Network structure interfaces enable access to the name of the node that the component administers, retrieval of the number of states of this node, a list of descriptions of the states and a list of the incoming links and the outgoing links of this node.

The conditional probability matrix interfaces enable access to the conditional probability matrix, and using these interfaces, calculations can be performed on the conditional probability matrix or its transpose (see equations 1 and 4).

The belief calculation interfaces allows access to π(x), λ(x) and BEL(x) (see equations 1, 2 and 5).

The environmental interfaces enable interaction with the environment. If learn flag is true, the evidence received from the environment is added to the history data, and the conditional probability table is updated. This is an incremental learning process. If learn flag is false, no learning takes place, but the evidence is taken into account during belief propagation. This form of evidence setting is done when “what-if” queries are executed against the Bayesian Network.

Link Component

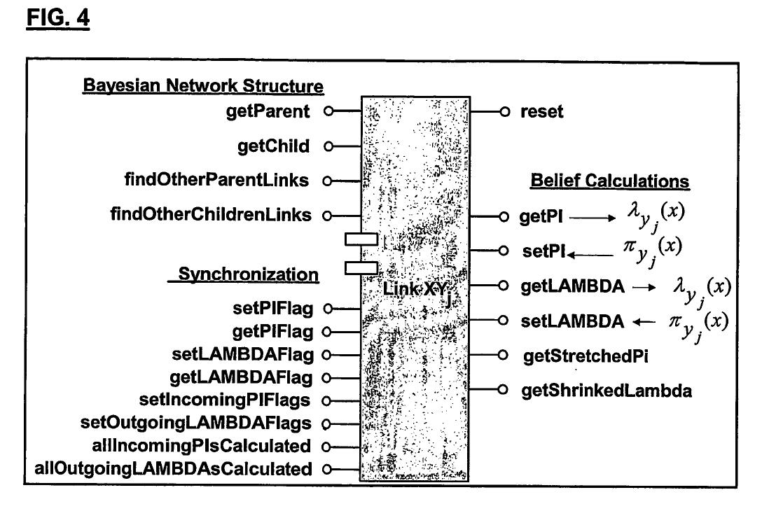

The component diagram for link component XYⱼ, is given in FIG. 4. The link component maintains and administers λ_{Y}_{ⱼ}(x) (see equation 3), λ_{Y}_{ⱼ}(x) (see equation 4) and synchronization flags (PIFlag and LAMBDAFlag).

The Bayesian Network structure interfaces enable access to the name of the parent node and child node of the link that the component administers, retrieval of a list of the other outgoing (sibling) links of the parent node as well as retrieval of a list of the other incoming (child) links of the child node.

The belief calculation interfaces allows access to π_{Y}_{ⱼ}(x) and λ_{Y}_{ⱼ}(x) (see equations 3 and 4).

The synchronization interfaces are used by the belief propagation components to synchronize the calculation of products of π's or λ's of sibling links. The PIFlag keeps track if link XYⱼ has calculated π_{Y}_{ⱼ}(x) or not, and the LAMBDAFlag keeps track if link XYⱼ has calculated λ_{Y}_{ⱼ}(x) or not.

The allIncomingPIsCalculated interface enables access to a flag that indicates if all the siblings of this link, that are also incoming links of this link's child node, have calculated their link π's yet. As soon as this flag is true, the product of π's of all the incoming links of the child node can be calculated. As soon as this product is calculated, the setIncomingPIFlags interface is used to set setIncomingPIsFlag in the link component to true. As soon as this flag is set, the link component will clear all the PIFlags of all the child node's incoming links and then set setIncomingPIsFlag to false again—ready for the calculation of the next product of π's.

The allOutgoingLAMBDAsCalculated interface enables access to a flag that indicates if all the siblings of this link, that are also outgoing links of this link's parent node, have calculated their link λ's yet. As soon as this flag is true, the product of λ's of all the outgoing links can be calculated. As soon as this product is calculated, the setOutgoingLAMBDAFlags interface is used to set setOutgoingLAMBDAsFlag in the link component to true. As soon as this flag is set, the link component will clear all the LAMBDAFlags of all the parent node's outgoing links and then set setOutgoingLAMBDAsFlag to false again—ready for the calculation of the next product of λ's.

Belief Propagation Component

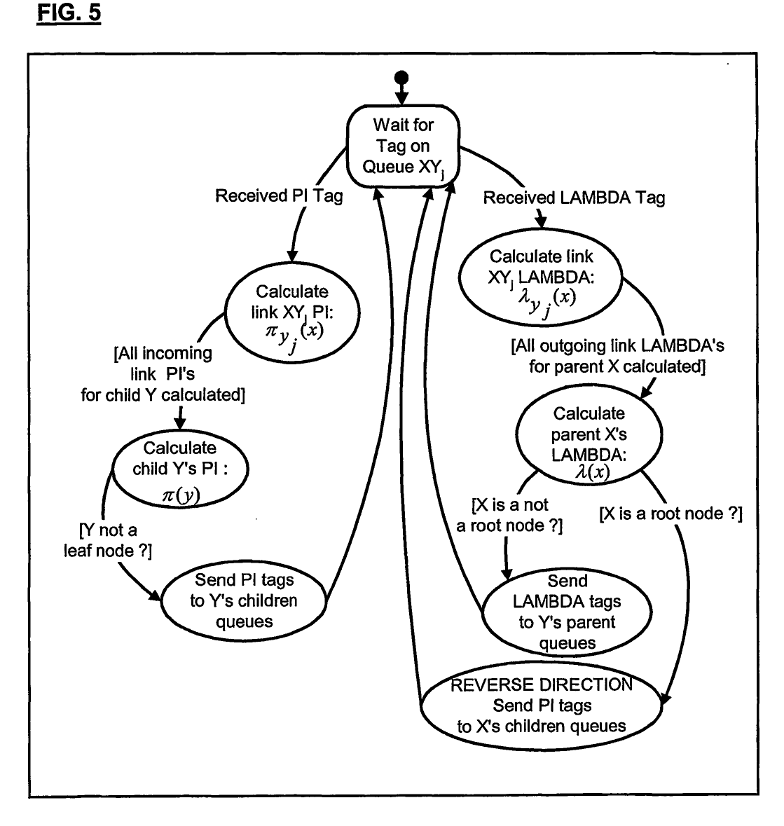

Bayesian etwork links are implemented using communication queues, one for each link in the network. Each communication queue has a belief propagation component listening on it. The messages communicated on the communication queues are simple tags—LAMBDA tags or PI tags. These tags determine the direction of propagation in the Bayesian Network. FIG. 5 is a state diagram for a belief propagation component that illustrates the processes triggered by these is tags.

As soon as a belief propagation component receives a tag, it first identifies the queue it received the tag on, in order to know which link in the Bayesian Network the queue corresponds to. Once the link is known to the belief propagation component, it creates the link and node components needed to access the underlying Bayesian Network information.

A PI tag will trigger the calculation of the link's π. If all the child node's incoming links have calculated their link π's, then the child node's π is calculated. As soon as the child node's π is updated, PI tags are sent to the queues corresponding to its outgoing links if it is not a leaf node. The belief propagation component will then go into a wait state, listening for the next tag to arrive on its queue.

A LAMBDA tag will trigger the calculation of the link's λ. If all the parent node's outgoing links have calculated their link it's, then the parent node's A is calculated. As soon as this node's A is updated, LAMBDA tags are sent to the queues corresponding to the parent node's incoming links if it is not a root node, otherwise Pi tags are sent to the queues corresponding to its outgoing links. The belief propagation component will then go into a wait state, listening for the next tag to arrive on its queue.

Each belief propagation cycle is a two-phase process, which is activated as soon as a set of evidence is received from the environment. The propagation of LAMBDA tags upwards from the leaf nodes through the network gathers evidence from the environment, followed by the flow of PI tags downwards from the root nodes, gathering a priori information. A LAMBDA tag will cause propagation of LAMBDA tags upwards in the direction of predecessor nodes, except if the parent of the link is a root node. In this case, the direction will be reversed and PI tags will be propagated towards the children nodes. A PI tag will cause propagation of PI tags in the direction of children nodes, except if the child of the link is a leaf node.

In the next two sections, the processes triggered by the different tags are described in more detail. These processing steps must be studied in conjunction with Judea Pearl's message passing algorithm as well as the link and component diagrams in FIGS. 3 and 4.

Handling PI Tags

Each PI tag received on a queue representing link XYⱼ, triggers the following processing steps:

1. Create a link component corresponding to the link XYⱼ

a. Use the getParent and getChild node component interfaces to determine the names of the parent (X) and the child node (Yⱼ) of this link.

b. Use the findOtherParentLinks interface to retrieve a list of the names of all siblings of this link that have the same parent as this link—in other words, all the other outgoing links of the parent node. The returned list of links will be {XY₁, XY₂ . . . XYⱼ₊₁ . . . XYₘ}

c. Use the findOtherChildrenLinks interface to retrieve a list of the names of all siblings of this link that have the same child as this link—in other words, all the other incoming links of the child node. The returned list of links will be {V₁Yⱼ, . . . VₚYⱼ}

2. For each of the other sibling links that are outgoing links of the parent link X, create a link component and use the getLAMBDA interface to retrieve λ_{Y}_{ₖ}(x), k=1 . . . m. Calculate the product of these link λ's, namely

$${\prod }_{k \neq j}^{} {λ}_{{Y}_{k}} ( x )$$

(x)

3. Use the getBelief interface to retrieve the belief of node X, namely BEL(x), and calculate π_{Y}_{ⱼ}

$${π}_{{Y}_{j}} ( x ) = BEL ( x ) {\prod }_{k \neq j}^{} {λ}_{{Y}_{k}} ( x ) ,$$

using the product of λ's calculated in the previous step. Note that this equation differs from (equation 3) in that BEL(x) is used instead of π(x).

4. Use the link component for link XYⱼ to:

a. set π_{Y}_{ⱼ}(x) using the interface setPI. Use the setPIFlag interface to set the flag to indicate that this link has now calculated its π.

b. Test if the other incoming sibling links have calculated their π's yet, by accessing the allIncomingPIsCalculated interface.

c. If this link is the last link to calculate its π, the π for child node Yⱼ can now be calculated. Use the interface setIncomingPIFlags to set a flag that will indicate to the link component to clear all the PIFlags for all the incoming links to node Yj—ready for the next belief propagation cycle.

i. For each of the other sibling links that are incoming links of the child node Yⱼ, create a link component and retrieve π_{Y}_{ⱼ}(vᵢ), i=1 . . . p, using the getPI interfaces of these link components. Calculate the product of the link π's.

ii. Create a node component for child node Yⱼ and use its multiplyTransposeCPM interface to calculate the product of the conditional probability matrix and the product of the incoming link π's, calculated in the previous step. The result is π(yⱼ) which is updated using node component Yⱼ's setPI interface.

iii. If node Yⱼ has children nodes, then use node component Yⱼ's getOutgoingLinks interface to get a list of names of al the outgoing links of this child node. Place a PI tag on the communication queue corresponding to each of these link names.

Handling LAMBDA Tags

Each LAMBDA tag received on a queue, representing link XYⱼ, triggers the following processing steps:

1. Create a link component corresponding to the link XYⱼ.

2. Use the getParent and getChild node component interfaces to determine the names of the parent (X) and the child node (Yⱼ) of this link.

3. Use the findOtherParentLinks interface to retrieve a list of the names of all siblings of this link that have the same parent as this link—in other words, all the other outgoing links of the parent node. The returned list of links will be {XY₁, XY₂ . . . XYⱼ₋₁, XYⱼ₊₁ . . . XYₘ}.

4. Use the findOtherChildrenLinks interface to retrieve a list of the names of all siblings of this link that have the same child as this link—in other words, all the other incoming links of the child node. The returned list of links will be {V₁Yⱼ, . . . VₚYⱼ}.

5. For each of the other sibling links that are incoming links of the child node Yⱼ, create a link component and retrieve π_{Y}_{ⱼ}(v₁), i=1 . . . p. Calculate the product of the link π's.

6. Create a node component for child node Yⱼ and use the getLAMBDA interface to determine child node's λ(yⱼ). Use the multiplyCPM to calculate the product of λ(yⱼ) and the conditional probability matrix. Multiply this product with the product of the incoming link π's calculated in the previous step. The result is λ_{Y}_{ⱼ}(x).

7. Use the link component for link XYⱼ to:

set λ_{Y}_{ⱼ}(x) using the interface setLAMBDA. Use the setLAMBDAFlag interface to set the flag to indicate that this link has now calculated its λ.

Test if the other outgoing sibling links have calculated their λ's yet, by accessing the allOutgoingLAMBDAsCalculated interface.

If this link is the last link to calculate its λ, the λ for parent node X can now be calculated. Use the interface setOutgoingLAMBDAFlags to set a flag that will indicate to the link component to clear all the LAMBDAFlags for all the outgoing links from node X, ready for the next belief propagation cycle.

i. For each of the other sibling links that are outgoing links of the parent node X, create a link component and retrieve λ_{Y}_{ⱼ}(x), j=1 . . . m. Calculate the product of the link λ's. The result is λ(x) which is updated using the setLAMBDA interface.

ii. If node X has parent nodes, then use parent node X's getIncomingLinks interface to get a list of all the incoming links of this parent node. Place a LAMBDA tag on the communication queue corresponding to each of these link names.

iii. If node X has no parent nodes, then use parent node X's getOutgoingLinks to get a list of names of al the outgoing links of this node. Place a PI tag on the communication queue corresponding to each of these link names.

The belief propagation components collectively propagate beliefs given the current environmental state. This is a continuous process of sending tags on message queues representing the Bayesian Network topology. These tags trigger the revision of the belief of each node given the environmental states. The node components incrementally learn from environmental states by keeping history data and updating the conditional probability matrices in response to evidence received from the environment. The node and link components provide interfaces that are accessed and updated by the belief propagation components during belief propagation.

The belief propagation components collectively ensures that the underlying Bayesian Network always reflects the current environmental states as belief propagation continuously gathers all environmental evidence.

Depending on the beliefs of the node components, component behaviours can be activated in response to evidence from the environment. These actions become part of dynamic interaction with the environment.

The Bayes components are collectively observed to be intelligent. Their intelligence emerges from the interaction between the belief propagation, link and node components, and between the node components and the environment.

Bayesian Network

A Bayesian Network is a directed acyclic graph that consists of a set of nodes that is linked together by directional links. The nodes represent variables of interest. Each variable has a finite set of mutually exclusive states. The links represent informational or causal dependencies among the variables. The dependencies are given in terms of conditional probabilities of states that a node can have given the values of the parent nodes (Dechter, 1996) (Pearl & Russel, 2000). Each probability reflects a degree of belief rather than a frequency of occurrence. A Bayesian Network can either be singly-connected (without loops) or multiply-connected.

Notation:

Variables are denoted by upper-case letters, e.g. (X,Y,Z), and the states of variables in lowercase, for example (X=x,Y=y,Z=z), also shortened as (x,y,z)

Sets of variables are represented by bold-face uppercase letters, e.g. (X,Y,Z)

P(X=x) represents the probability that X=x, also shortened as P(x)

P(X=x|Y=y) is the conditional probability that X=x, given that Y=y, also shortened as P(x|y)

To each node X there is attached a conditional probability matrix P={P(X|pa(X))} and where pa(X) represents the parents of X.

For example for variable X with set of states {X₁, x₂ . . . xₘ} and Y with set states {y₁, y₂, . . . yₙ}, the conditional probability matrix P(y|x) represents the conditional probability of Y given X as follows:

$$P ( y \vert x ) = [ \begin{matrix}P ( {y}_{1} \vert {x}_{1} ) & P ( {y}_{2} \vert {x}_{1} ) & ⋯ & P ( {y}_{n} \vert {x}_{1} ) \\ P ( {y}_{1} \vert {x}_{2} ) & P ( {y}_{2} \vert {x}_{2} ) & ⋯ & P ( {y}_{n} \vert {x}_{2} ) \\ ⋮ & ⋮ & ⋮ & ⋮ \\ P ( {y}_{1} \vert {x}_{m} ) & P ( {y}_{2} \vert {x}_{m} ) & ⋯ & P ( {y}_{n} \vert {x}_{m} )\end{matrix} ]$$

For a set of variables Z=(Z₁, Z₂ . . . Zₙ) represented by a Bayesian Network, the network represents a global joint probability distribution over Z having the product form

P(z₁, . . . zₙ)=Πᵢ₌₁ⁿP(zᵢ|pa(zᵢ) (6)

A variable can be observable or latent. A latent or hidden variable is a variable of which the states are inferred but never observed directly.

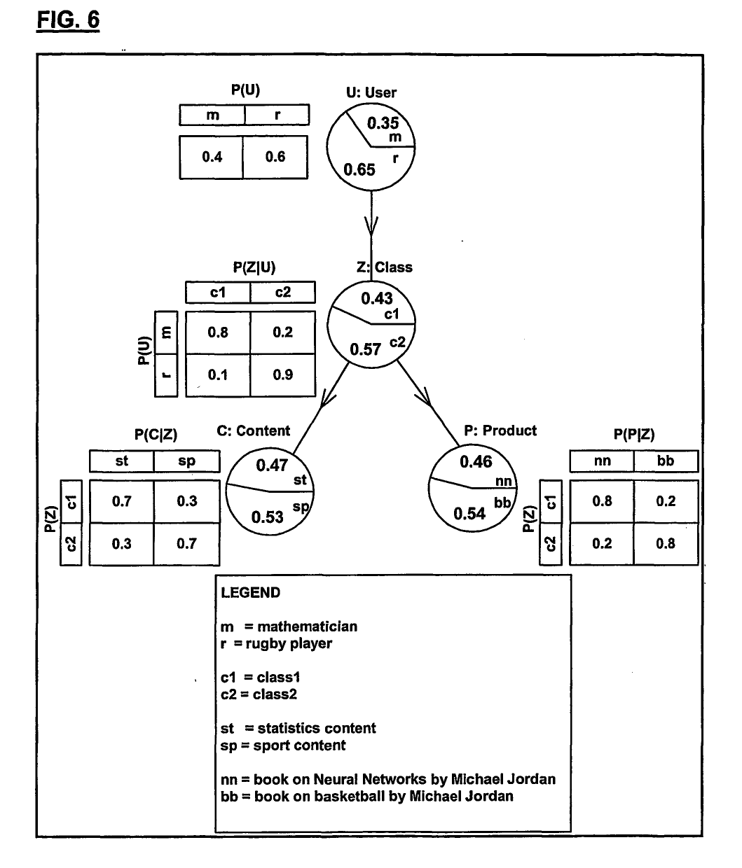

FIG. 6 illustrates a Bayesian Network based on the user-words aspect model proposed by Popescul, Ungar, Pennock & Lawrence (2001). This network models the relationship between users (U), the contents of browsed web pages characterized in terms of concepts (C), and products bought from these pages (P). This simple model includes three-way co-occurrence data among two users, two products and two concepts.

The users are represented by u ε U=(mathematician (m), rugby player(r)), the products by p ε P={book authored by Michael Jordan on neural networks (nn), book authored by Michael Jordan on basketball (bb)} and the concepts inferred from the web pages the users viewed by c ε C={statistics(st), sport(sp)}. The users (U), products (P) and concepts (C) form observations (u, c, p), which are associated with a latent variable class (Z).

This simple model have two latent classes, z ε Z={class1(c1), class2(c2)}. In FIG. 6, the conditional probability matrices are shown next to their nodes.

The example Bayesian Network represents the joint distribution:

P(u, z, c, p)=P(u)P(z|u)p(c|z)P(p|z) (7)

From (6) and (7) it can be seen that the global distribution is described in terms of local distributions. Pearl & Russel (2000) refers to equation (6) as the “global semantics” of a Bayesian Network, and further describes the “local semantics”, which asserts that each variable is independent of its nondescendants in the network given its parents. For example, in FIG. 6,

P(c|u, z)=P(c|z) (8)

The localized nature of Bayesian Networks as well as its local semantics makes this technology ideal for distributed implementation. Using Bayes rule, an equivalent joint distribution for (7) is given by

P(u,z,c,p)=P(z)P(u|z)P(c|z)P(p|z) (9)

The joint distribution over users, contents and products is given by

$$P ( u , c , p ) = {\sum }_{z}^{} P ( z ) P ( u \vert z ) p ( c \vert z ) P ( p \vert z ) \qquad ( 10 )$$

In a changing environment, some variables can have values that change over time. In dynamic Bayesian Networks, multiple copies of the variables are represented, one for each time step (Pearl & Russel, 2000).

Bayesian Learning

Bayesian learning can be described as the calculation of the conditional probability matrices from observations from the environment over a given time period.

There are different conditions that can influence Bayesian learning. The structure of the Bayesian Network can be known or unknown and the variables can be observable or hidden.

If the structure of the Bayesian network is known, and all the variables are observable, then the values of the conditional probability matrices are easy to calculate. If the structure is unknown and all the variables are observable, then the learning problem involves a search through the possible structures to find the structure that represents the data best, followed by the updating of the conditional probability matrices.

Algorithms for the case of a known structure and hidden variables include a local gradient-descent learning algorithm (Russel, Binder, Koller & Kanazawa, 1995) and the EM algorithm (Russel, 1998).

Popescul et al. (2001) illustrated the EM algorithm applied to their three-way aspect model. Applied to our three-way aspect model illustrated in FIG. 1, these calculations will be as follows:

Let n(u,c,p) be the number of times that a user u, interested in concepts c, bought product p. This can be calculated from n(u,c,p)=n(u,c) x n(c,p), where n(u,c) is the number of times that a user u accessed web pages containing concepts c and n(c,p)=the number of times product p was bought by users interested in concepts c. In the EM algorithm, a local maximum is found for the log likelihood L of the data (Popescul et al., 2001), which is:

$$L = {\sum }_{u , c , p}^{} n ( u , c , p ) log P ( u , c , p ) \qquad ( 11 )$$

where P(u, c, p) is given by equation (10).

Belief Propagation

Belief Propagation is the process of finding the most probable explanation (MPE) in the presence of evidence (e) from the environment. Dechter (1996) defines the MPE as the maximum assignment x in

$${max}_{x} P ( x ) = {max}_{x} {\prod }_{i = 1}^{n} P ( {x}_{i} \vert pa ( {x}_{i} ) , e ) \qquad ( 12 )$$

The overall belief in the proposition of x=x supported by all evidence (e) received so far is denoted by BEL(X=x)=BEL(x)≡P(x|e) where e denoted the total evidence available. BEL(X) indicates the set of all beliefs for node X.

Belief propagation is NP-hard (Dechter, 1996). Judea Pearl developed a message-passing algorithm for singly connected networks (Carnegie Mellon University, 1991). This algorithm was extended to general multi-connected networks by different researchers. Three main approaches exist, namely Judea Pearl's cycle-cutset approach (also referred to as conditioning), the tree-clustering approach and the elimination approach. The cycle-cutset and tree-clustering approaches work well only for sparse networks with small cycle-cutsets or clusters. The elimination approach is based on non-serial dynamic programming algorithms, which suffer from exponential space and exponential time difficulties. Dechter combined elimination and conditioning in order to address the problems associated with dynamic programming.

The belief propagation algorithms for general multi-connected networks generally have two phases of execution. In the first phase, a secondary tree is constructed. This can for example be a “good” cycle-cutset used during conditioning (Becker, Bar-Yehuda & Geiger, 2000) or an optimal junction tree used by tree-clustering algorithms (Jensen, Jensen & Dittmer, 1994). In the second phase, the secondary tree structure is used for inference. Becker et al. argue that finding a “good” cycle-cutset is NP-complete and finding an optimal junction tree is also NP-complete (Becker & Geiger, 1996). A number of approximation algorithms were developed to find the secondary trees, as in (Becker et al.) (Becker & Geiger).

It is possible to use the original tree during belief propagation. Diez (1996) describes a conditioning algorithm that uses the original Bayesian network during belief propagation and detects loops using the DFS (Depth-First Search) algorithm.

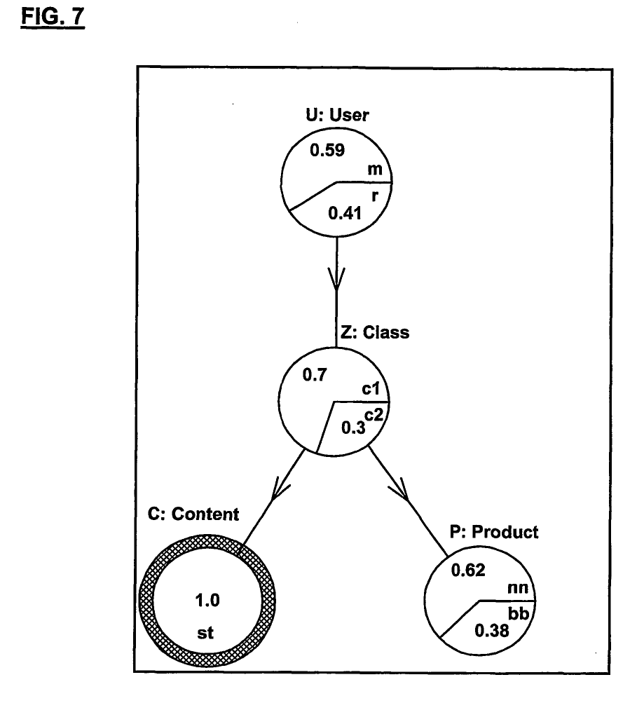

FIG. 7 illustrates the results of belief propagation in the presence of evidence.

Node C, the evidence node, is circled. The new beliefs updated during belief propagation are indicated on nodes P, Z and U. In the presence of the evidence, namely that a user is interested in statistical concepts, the belief that he will be interested in a book on neural networks authored by professor Michael Jordan rises from 0.46 to 0.54.

Component-Based Software Engineering

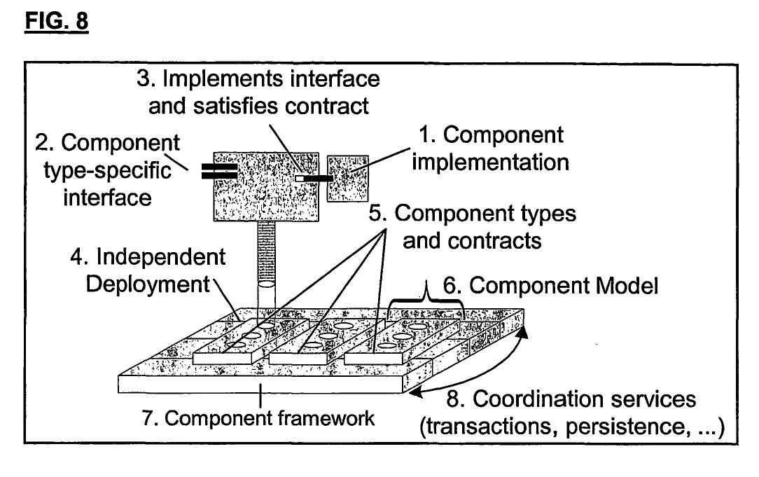

Component-based software engineering uses component-based design strategies. A design strategy can be viewed as an architectural style consisting of high level design patterns described by the types of components in a system and their patterns of interaction (Bachman et al., 2000). Bachman et al. illustrated and defined a reference model for component-based concepts, illustrated by FIG. 8 and summarized below.

A component (1) is a software implementation that can be executed on a physical or a logical device. A component implements one or more interfaces that are imposed on it (2). By doing this, the component satisfies certain obligations, called a contract (3). These contractual obligations ensure that independently developed components obey certain rules so that components can interact (or not interact) in predictable ways, and can be deployed into standard run-time environments (4). A component-based system is based upon a small number of distinct component-types, each of which plays a specialized role in a system (5) and is described by an interface (2). A component model is the set of component types, their interfaces, and additionally, a specification of the allowable patterns of interaction among component types. A component framework (7) provides a variety of runtime services (8) to support and enforce the component model. Hopkins (2000) defines a component as follows:

A software component is a physical packaging of executable software with a well-defined and published interface.

In the current UML specification, UML1.4 (UML Revision Task Force, 2001), a component is described as follows:

A component represents a modular, deployable, and replaceable part of a system that encapsulates implementation and exposes a set of interfaces.

Hopkins further identifies the engineering drivers in the development of a component-based system as:

Reuse: The ability to reuse existing components to create a more complex system

Evolution: A componentized system is easier to maintain. In a well-designed system, components can be changed without affecting other components in the system.

Components publish their interfaces and communicate with each other within component models such as Microsoft's DCOM (Distributed Component Object Model), the Object Management Group's CORBA (Common Object Request Broker Architecture) and Sun's Enterprise JavaBeans.

Prototype Implementation

Prototype belief propagation, node and link components were implemented as reusable components using Sun's Enterprise JavaBeans™ component architecture.

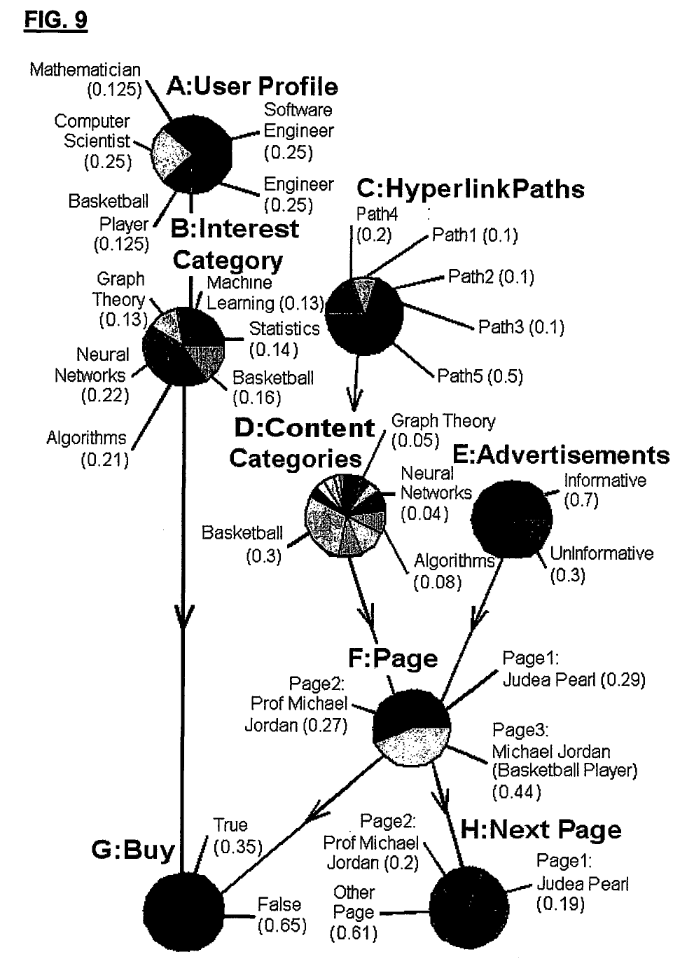

FIG. 9 illustrates a Bayesian Network that is a fictitious model of the browsing behaviour of users visiting an electronic bookstore website. This network models the relationships between the type of user that browses the site (A), their interests (B), the sequence of hyperlinks that they clicked to access the pages (C), content categories of all the pages on the website (D), the information content of the advertisements on the web pages (E), the pages they view (F), the pages that they will visit next (H) and the buying behaviour per page (G). Each of these nodes represents emergent behaviours, with a few example states. Our example website have hyperlinks to the following pages:

Page 2: books by professor Michael Jordan on graph theory and probability theory;

Page 3: books by/related to Michael Jordan, the well-known basketball player;

Other Page: any other page on the website.

The hyperlink paths to these pages are:

Path 1: Engineering and Science→Mathematics→Graph Theory→Page 1 & 2;

Path 2: Engineering and Science→Mathematics→Probability and Statistics→Page 1 & 2;

Path 3: Computers and Internet→Artificial Intelligence→Machine Learning→Neural Networks→Page 2;

Path 4: Computers and Internet→Programming→Software Engineering Algorithms→Page 1 & 2;

Path 5: General Interest→Sports and Adventure→Basketball→Page 3.

Table 1 gives the conditional probability matrix associated with node B.

TABLE 1
Conditional Probability Matrix for Node B InterestCategory
P(B: InterestCategory | A: UserProfile)

| B: | A: UserProfile | | | | |
|---|---|---|---|---|---|
| Interest | En- | Mathe- | Computer | Software | Basketball |
| Category | gineer | matician | Scientist | Engineer | Player |
| Graph Theory | 0.1 | 0.25 | 0.1 | 0.2 | 0.01 |
| Statistics | 0.2 | 0.34 | 0.1 | 0.1 | 0.01 |
| Machine | 0.1 | 0.1 | 0.25 | 0.1 | 0.01 |
| Learning | | | | | |
| Neural | 0.3 | 0.2 | 0.25 | 0.2 | 0.01 |
| Networks | | | | | |
| Algorithms | 0.25 | 0.1 | 0.25 | 0.3 | 0.01 |
| Basketball | 0.05 | 0.01 | 0.05 | 0.1 | 0.95 |

In this simple model, buying behaviour (G) depends on the current page that is being browsed (F), and the categories of interest of a particular user (B), which in turn depends on the user profile (A). For simplicity, users are profiled on their profession only. The website contents can be categorized into content categories (D), which are distributed between different pages (F). In order not to clutter the diagrams, only a few content categories are indicated next to node D. The choice of a page (F) depends on how well its contents matches the content categories (D) that the user is looking for and how well the content categories were advertised to the user (E). The hyperlinks to the pages (C) are related to the content categories (D) that a user is looking for. The relationship between the current page (F) that is being viewed and the next page (H) that will most probably be browsed next is also modeled in this network.

The belief in the absence of evidence is indicated next to each of the nodes in FIG. 9. For example, the beliefs of the user profile node (A) indicate that mathematicians and basketball players browse this site with equal probability of 0.125. The beliefs of the hyperlink paths node (C) indicate that Path 5 will most probably be chosen (0.5) and the beliefs of the content categories (D) indicate that the basketball category is most likely to be searched for (0.3). The beliefs of the page node (F) show that the Michael Jordan (the well-known basketball player) page will most probably be viewed (0.44). The beliefs of the advertisements node (E) show that the advertisements that led the user to this page were informative with a probability of 0.7. The beliefs of node (G) show that the probability that a user will buy a book when visiting a page is 0.35. The probability that a user would be interested to view books by Michael Jordan (the professor) next is 0.2.

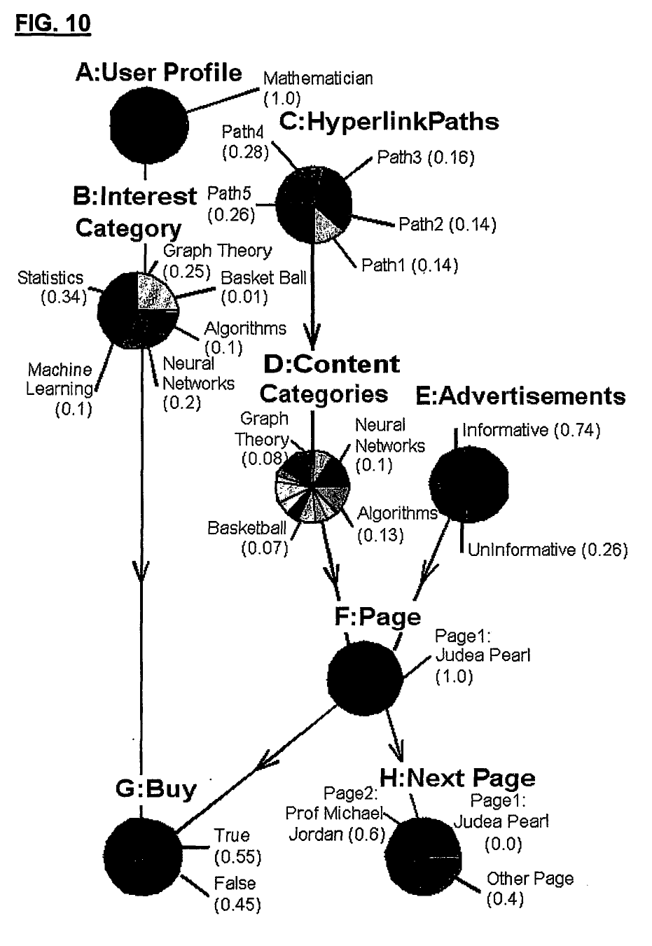

FIG. 10 illustrates the results of belief propagation in the presence of evidence. A mathematician that browses a website listing books on Bayesian Networks by Judea Pearl is most probably interested in statistics (0.34), graph theory (0.25) and neural networks (0.2). He would have chosen hyperlink path 4 with the highest probability (0.28) in order to search for algorithms related to his field if interest. He will buy a book from this page with a probability of 0.55. The probability that this user will be interested to view books by professor Michael Jordan next has now risen to 0.6 and the probability that the advertisements were informative has now increased to 0.74.

Bayesian Network Configuration

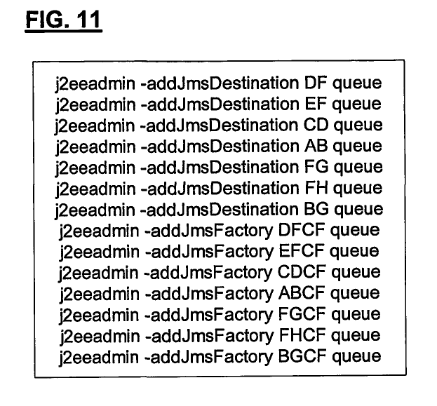

The configuration of the Bayesian Network was done manually. The JMS queues for the links in FIG. 10 were created using the j2eeadmin tool, as illustrated in FIG. 11.

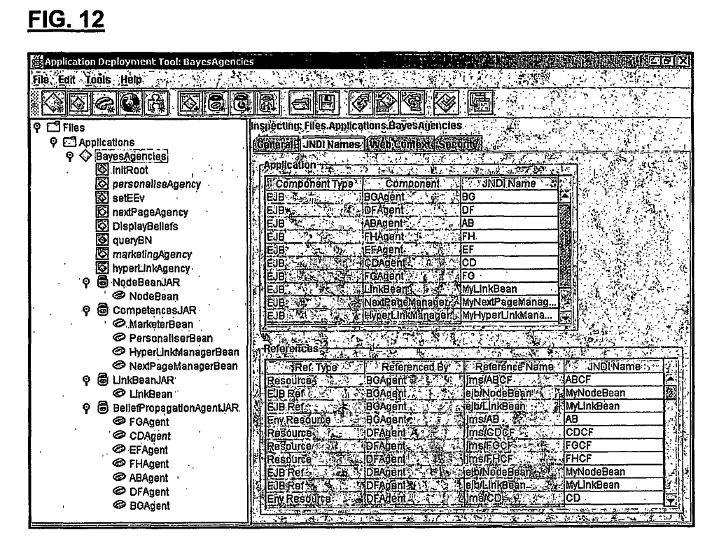

In FIG. 12, the components for the Bayesian Network in FIGS. 9 and 10 is given. The NodeBeanJAR contains the node component, and the LinkBeanJAR contains the link component. The BeliefPropagationAgentJAR contains the belief propagation components, where XYAgent is the belief propagation component listening on JMS queue XY. FIG. 9 shows the assignment of the belief propagation components (“agents”) to the JMS queues, using the J2EE deployment tool.

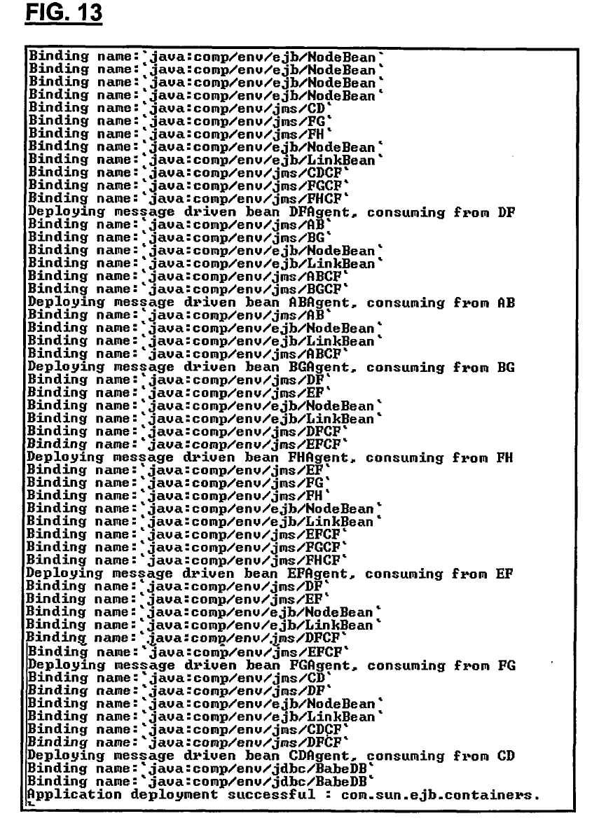

FIG. 13 shows the output of the J2EE server on startup, with the belief propagation components listening on the JMS queues representing the Bayesian Network topology.

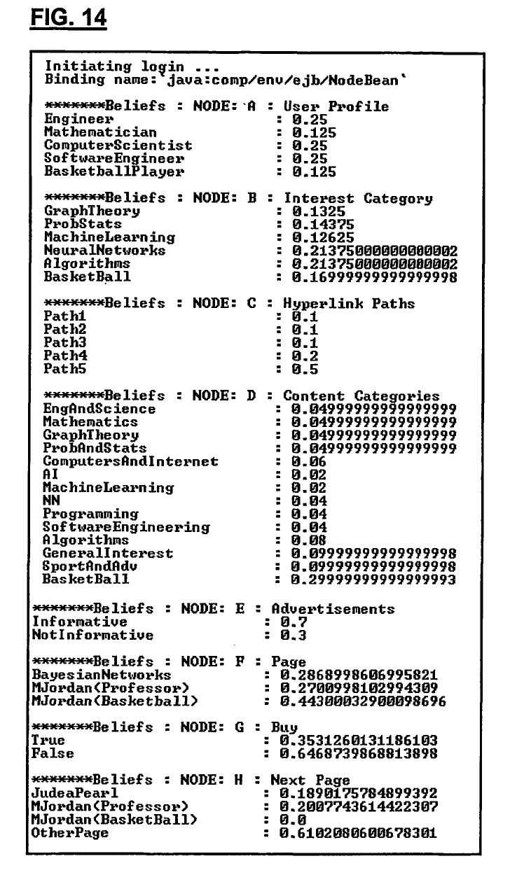

FIG. 14 displays the beliefs of the Bayesian Network in the absence of evidence. These beliefs are also illustrated in FIG. 9.

Bayesian Network Querying

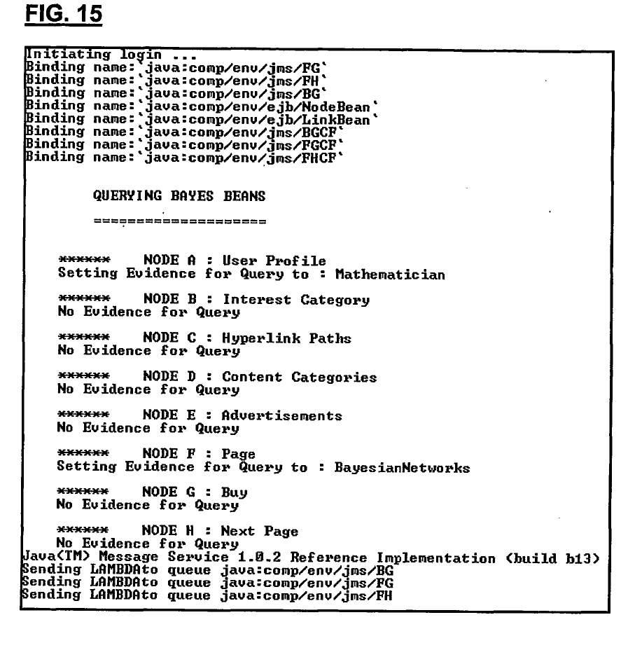

FIG. 15 displays the output of a client setting evidence in order to query the Bayesian Network. In this mode, the node components do not learn from the evidence presented to them.

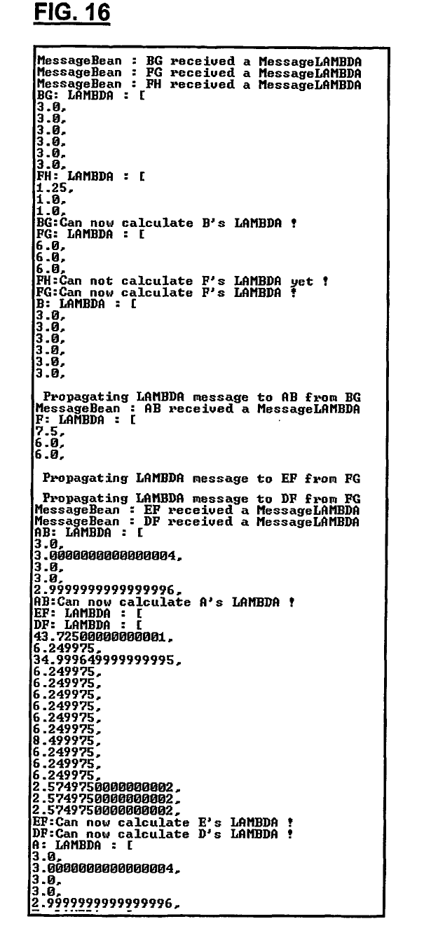

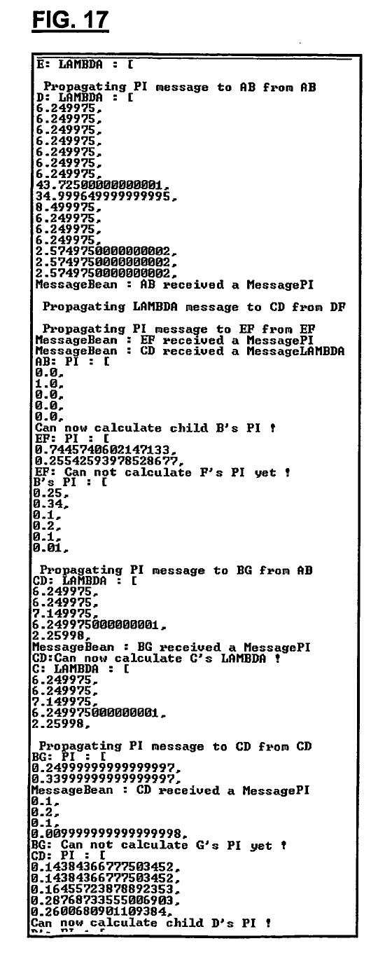

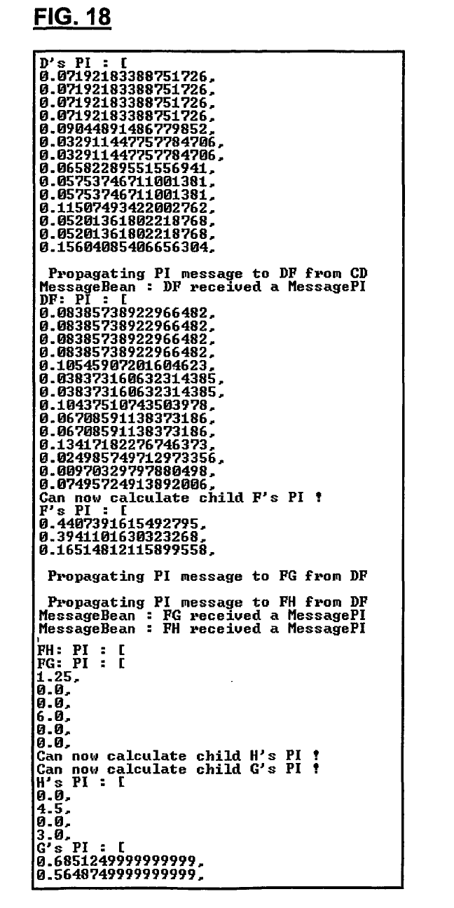

FIGS. 16 to 18 is the output trace of the belief propagation components, in response to the evidence presented to it in FIG. 15 above. This evidence is also illustrated in FIG. 10.

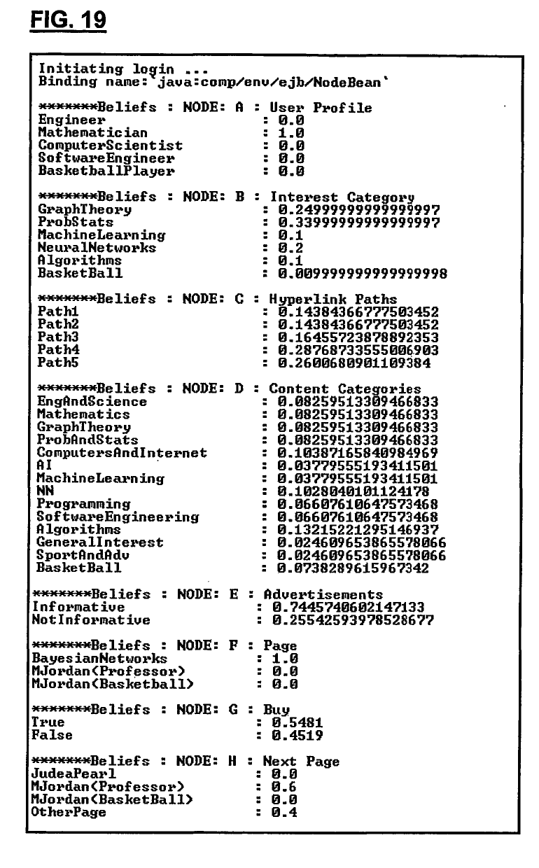

FIG. 19 shows the beliefs of the nodes after belief propagation with evidence and no learning (compare with FIG. 10).

Bayesian Network Learning

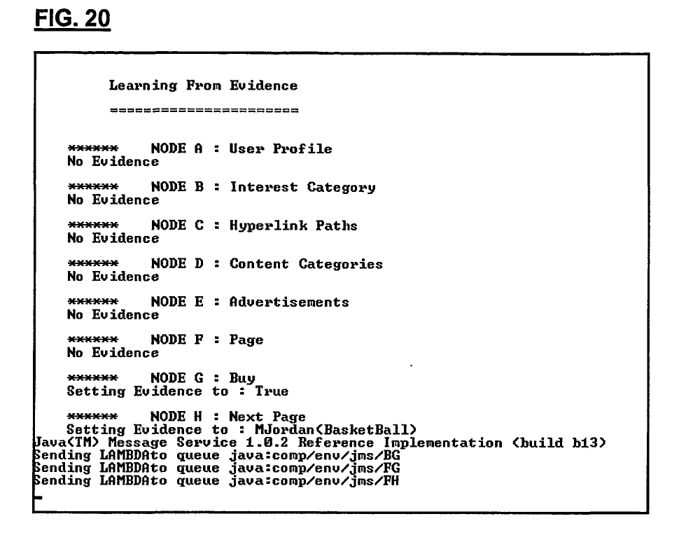

FIG. 20 displays the output of a client presenting evidence to the Bayesian Network. In this mode, the node components learn from the evidence presented to them, namely that a user that browsed Michael Jordan's the basketball player's page next, bought a product from the web page that he browsed before.

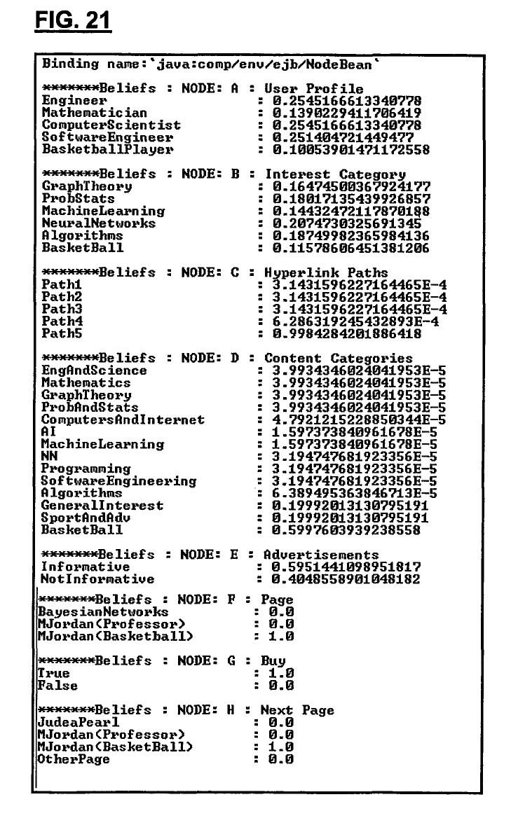

FIG. 21 displays the results after belief propagation in the presence of the evidence presented in FIG. 20.

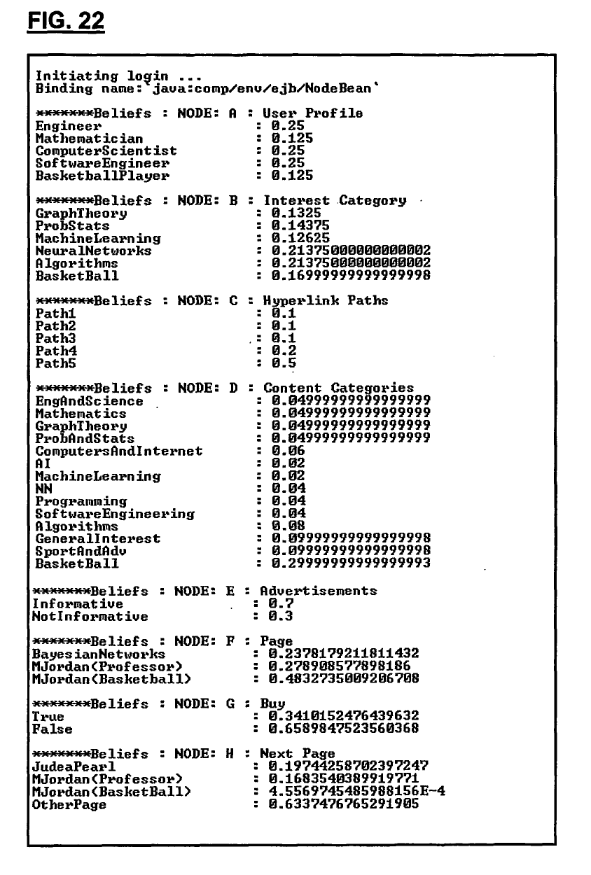

FIG. 22 illustrates the new beliefs after learning, in the presence of no evidence from the environment. Compare the new beliefs, with the original beliefs in FIG. 14. The beliefs of nodes F, G and H have changed.

The CompetencesJAR in FIG. 11 contains the competence components, namely MarketerBean, NextPageManagerBean, HyperLinkManagerBean and PersonaliserBean. The competence components have interfaces to the behaviours or actions that the competence agencies can execute.

A competence set Θᵢ is a tuple (Cᵢ,Aᵢ), where Cᵢ is a set of constraints on a subset of nodes and their states in the Bayesian Network, and the Aᵢ is a set of actions that must be executed if all the constraints in Cᵢ are met.

The competence sets for FIGS. 9 and 10 is as follows:

Let Θ={Θ₁,Θ₂,Θ₃,Θ₄}

Θ₁={ [symbol] , {the set of actions associated with the personalization of the web pages depending on BEL(B), BEL(D)}. This set specifies that the specified actions must be executed unconditionally as there are no constraints in this set;

[symbol] ₂={ [symbol] , {the set of actions associated with the dynamic creation of hyperlinks to web pages, depending on BEL(C), BEL(D), BEL(F)}}. This set specifies that the specified set of actions must be executed unconditionally as there are no constraints in this set;

η₃={{BEL(E=Uninformative)>0.4}, {inform the marketing department how informative advertisements were—BEL(E), and how it influenced the buying BEL(G)}}. This set specifies that the specified actions must be taken if the belief that the advertisements were uninformative exceeded a threshold of 0.4;

Θ₄={ [symbol] , {the set of actions associated with the display links to web pages that might interest the user next, depending on BEL(H)}}. This set specifies that the specified set of actions must be executed unconditionally as there are no constraints in this set.

Component behaviours were created for all possible actions that must be executed by the agencies. Each competence agency implements a competence set Θᵢ=(Cᵢ,Aᵢ), where Cᵢ is a set of constraints on a subset of nodes and their states in the Bayesian Network, and the Aᵢ is a set of component actions that must be executed if all the constraints in Cᵢ are met. Each Competence Agency consists of the node components for the nodes in the constraint set, as well as the node components created by the component behaviours. The beliefs of the nodes are accessed using the getBelief node interfaces, and used to test if the beliefs satisfy al the constraints in the constraint set. If all the constraints are met, the component behaviours can be executed.

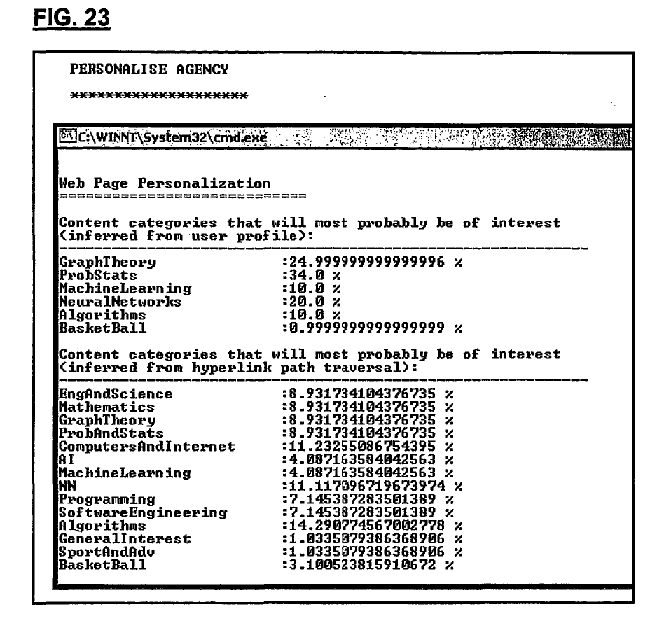

The personaliseAgency implements competence set Θ₁={ [symbol] , personaliseWebPage}. It (unconditionally) calls the personaliseWebPage interface of the PersonaliserBean. FIG. 23 is a screen dump of the output of personaliseWebPage, which in this simple example displays the beliefs of nodes B and D, after belief propagation in the presence of a mathematician browsing a website listing books on Bayesian Networks by Judea Pearl. (Note that the probabilities are the same as in FIG. 10).

### LIST OF REFERENCES

Bachman, F. Bass, L. Buhman, C. Comella-Dorda, S. Long, F. Robert, J. Seacord, R. & Wallnau, K. (2000, May). Volume II: Technical Concepts of Component-Based Software Engineering

http://www.sei.cmu.edu/staff/rcs/CBSE-papers.html.

Becker, A., Bar-Yehuda, R. & Geiger, D. (2000). Randomized Algorithms for the Loop Cutset Problem. Journal of Artificial Intelligence Research, 12, 219-234.

http://www.cs.washington.edu/research/iair/abstracts/becker00a. html

Becker, A. & Geiger, A. (1996). A sufficiently fast algorithm for finding close to optimal junction trees. Proceedings of the Twelfth Conference on Artificial Intelligence, 81-89.

http://www.cs.technion.ac.il/˜dang/

Carnegie Mellon University (1991). BAYES: Tree-structured Bayesian belief network.

http://www.cs.cmu.edu/˜mkant/Public/util/areas/reasonng/probabl/bayes/bayes.aug

Dechter, R. (1996). Bucket Elimination: A Unifying Framework for Probabilistic Inference. Uncertainty in Artificial Intelligence, UAI96, 211-219.

http://www.ics.uci.edu/˜dechter/publications/

Diez, F. J. (1996). Local Conditioning in Bayesian Networks. Artificial Intelligence, 87, 1-20.

http://www.dia.uned.es/˜fjdiez

Gell-Mann, M. (1994). The Quark and the Jaquar (Second ed.). London: Abacus. Hopkins, J. (2000). Component Primer. Communications of the ACM, 43(10), 27-30.

Jensen, F., Jensen, F. V. & Dittmer, S. L. (1994). From Influence Diagrams to Junction Trees, Proceedings of the Tenth Conference of Uncertainty in Artificial Intelligence.

http://www.cs.auc.dk/research/DSS/abstracts/jensen:jensen:dittmer:94.html

Pearl, J. & Russel, S. (2000). Bayesian Networks, Technical Report R-277, UCLA Cognitive Systems Laboratory.

http://bayes.cs.ucla.edu/csl.papers.html

Popescul, A. Ungar, L. H., Pennock, D. M., & Lawrence, S. (2001). Probabilistic Models for Unified Collaborative and Content-Based Recommendation in Sparse-Data Environments.

http://www.cis.upenn.edu/˜popescul/publications.html

Russel, S. (1998). The EM Algorithm.

http://citeseer.nj.nec.com/russell98em.html

Russel, S. J., Binder, J. Koller, D. & Kanazawa, K. (1995). Local learning in probabilistic networks with hidden variables. Proceedings of the Fourteenth International Joint Conference on Artificial Intelligence, 1146-1152.

http://robotics/stanford/edu/˜koller/papers/apnijcai.html

1. A complex adaptive system which comprises an intelligent software system for controlling behaviour in an application domain, the intelligent software system being deployed in an environment and being adapted to
(a) receive evidence from various sources in the environment;
(b) learn from the evidence; and
(c) modify the behaviour in order to adapt to changes in the environment.

2. A system as claimed in claim 1, in which the intelligent software system is a Bayesian network.

3. A system as claimed in claim 1 or claim 2, in which the environment is a distributed environment.

4. A system as claimed in claim 2 or claim 3, in which the Bayesian network comprises
(a) nodes representing variables of interest;
(b) node components for implementing and administering the nodes;
(c) links connecting a first node and a second node and representing dependencies among the variables of interest;
(d) link components for administering the links;
(e) belief propagation components for propagating beliefs of the Bayesian network; and
the Bayesian network resides within a component framework having communication queues for implementing the links, and providing an infrastructure for the node components, the link components and the belief propagation components.

5. A system as claimed in claim 4, in which a belief propagation component is provided for each communication queue.

6. A system as claimed in claim 4 or claim 5, in which the node components, the link components and the belief propagation components are re-usable components.

7. A system as claimed in any one of claims 4 to 6, in which the node components, the link components and the belief propagation components are components of a component architecture.

8. A system as claimed in any one of claims 4 to 7, in which the node components are identical node components but created for different nodes and the link components are identical link components but created for different links and the belief propagation components are identical belief propagation components but created for different communication queues.

9. A system as claimed in any one of the preceding claims, in which the learning is incremental.

10. A system as claimed in any one of claims 4 to 9, which comprises a database for storing conditional probability matrices and the database being administered by the node components and the link components.

11. A system as claimed in claim 10, which the database comprises a topology of the Bayesian network.

12. A system as claimed in claim 10 or claim 11, in which the belief propagation components communicate with each other directly via the communication queues by means of tags and indirectly via data in the database.

13. A system as claimed in any one of the preceding claims, in which the various sources are selected from the group comprising user-input data, data-sources and sensor data.

14. A system as claimed in claim 12, in which the tags are simple messages controlling belief propagation.

15. A system as claimed in any one of claims 4 to 14, in which the node components receive evidence, maintain record of occurrences, maintain conditional probability matrices, and learn from evidence received from the various sources.

16. A system as claimed in any one of claims 4 to 15, in which the belief propagation components collectively find a most probable explanation (MPE) for the Bayesian network given the evidence.

17. A system as claimed in any one of claims 10 to 16, in which the database is distributed.

18. A system as claimed in any one of claims 4 to 17, in which the propagating of beliefs is localized for a parent node, a child node and the corresponding link between the parent node and the child node.

19. A system as claimed in any one of claims 4 to 18, in which the node components interface with the environment.

20. A system as claimed in any one of claims 4 to 19, in which the learning occurs by updating conditional probability matrices of the nodes in response to evidence.

21. A system as claimed in any one of claims 4 to 20, in which belief propagation components calculate π's and λ's for a parent node, a child node and a corresponding link as in Judea Pearl's message passing algorithm.

22. A system as claimed in any one of claims 4 to 21, which comprises control of the belief propagation and which control is distributed between the belief propagation components.

23. A system as claimed in any one of claims 4 to 22, in which each link component corresponding to any link XY maintains and administers
(a) π_{Y}(x) as defined in Judea Pearl's Message Passing Algorithm;
(b) λ_{Y}(x) as defined in Judea Pearl's Message Passing Algorithm; and
(c) synchronization flags.

24. A system as claimed in any one of claims 4 to 23, in which each node component corresponding to any node X maintains and administers
(a) π(x) as defined in Judea Pearl's Message Passing Algorithm; and
(b) λ(x) as defined in Judea Pearl's Message Passing Algorithm;

25. A system as claimed in any one of claims 12 to 24, in which the tags comprise PI-tags and LAMBDA-tags for determining the direction of propagation in the Bayesian Network.

26. A system as claimed in claim 25, in which each belief propagation cycle is a two-phase process, which is activated as soon as a set of evidence is received from the environment, the two-phase process comprising
(a) propagation of LAMBDA-tags from nodes without any outgoing links in the direction of predecessor nodes through the network gathering evidence from the environment; and
(b) thereafter flow of PI-tags from nodes without any incoming links in direction of children nodes, gathering a priori information.

27. A system as claimed in any one of claims 7 to 26, in which the node component corresponding to any node X comprises component interfaces:
(a) for initialising or resetting node X;
(b) for enabling access to the topology of the Bayesian network;
(c) for enabling access to node X's conditional probability matrix and for performing calculations on the conditional probability matrix as defined in Judea Pearl's Message Passing Algorithm;
(d) for allowing access to π(x), λ(x) and BEL(x); and
(e) for enabling interaction with the environment.

28. A system as claimed in any one of claims 7 to 27, in which the link component corresponding to any link XY comprises component interfaces:
(a) for initialising or resetting link XY;
(b) for enabling access to the topology of the Bayesian network;
(c) for allowing access to π_{Y}(x) and λ_{Y}(x); and
(d) for synchronizing calculation of products of π's or λ's of other links with either a parent node X or a child node Y.

29. A method of operating a complex adaptive system which comprises the steps of:
(e) deploying in an environment an intelligent software system for controlling behaviour in an application domain; and
(f) adapting the intelligent software system to receive evidence from various sources in the environment, to learn from the evidence, and to modify the behaviour in order to adapt to changes in the environment.

30. Computer-readable media storage instructions for carrying out the steps of the method as claimed in claim 29.
